(19) United States
(12) Patent Application Publication
(10) Pub. No.: US 2009/0044501 A1
(43) Pub. Date: Feb. 19, 2009

(54) Dust separating apparatus

(75) Inventor: Cheol-ho Choi, Gwangju-city (KR)

Correspondence Address: BLANK ROME LLP, 600 NEW HAMPSHIRE AVENUE, N.W., WASHINGTON, DC, 20037, US

(73) Assignee: Samsung Gwangju Electronics Co., Ltd.

(21) Appl. No.: 12/010,240

(22) Filed: Jan. 23, 2008

(30) Foreign Application Priority Data
Aug. 17, 2007 (KR) 2007-82955

(51) Int. Cl. B01D 45/14

(52) U.S. Cl. 55/337

(57) ABSTRACT

A dust separating apparatus is provided, including a main body having a cylindrical shape and including a suction port on a bottom surface and an open upper part, a cover that covers the upper part of the main body and includes a discharge port formed on the same axis as the suction port; and an air guide member protruding from the suction port to the inside of the main body, wherein the air guide member allows the suction port to be in fluid communication with the main body when suction force is generated in the main body and does not allow the suction port to be in fluid communication with the main body when suction force is not generated in the main body.

### CROSS-REFERENCE TO RELATED APPLICATIONS

This application claims the benefit under 35 U.S.C. § 119(a) of Korean Patent Application No. 10-2007-0082955, filed Aug. 17, 2007, in the Korean Intellectual Property Office, the disclosure of which is incorporated herein by reference in its entirety.

Also, this application may be related to commonly-owned copending U.S. Pat. No. 7,074,248, filed Sep. 12, 2003, entitled “Filter Cleaning Device of Cyclone Vacuum Cleaner” by Hyoung-Jong Jin, the disclosure of which is incorporated herein by reference.

### FIELD OF THE INVENTION

The present invention relates to a dust separating apparatus for a vacuum cleaner. More particularly, the present invention relates to a dust separating apparatus for a vacuum cleaner that separates dust from drawn in dust-laden air

### BACKGROUND OF INVENTION

In general, a dust separating apparatus for a vacuum cleaner is an apparatus that separates dust from drawn in dust-laden air, and discharges cleaned air to the outside. Among conventional dust separating apparatuses, cyclone dust separating apparatuses draw dust-laden air into a cyclone body through a suction port so rotating air current is generated, separating dust from the dust-laden air by centrifugal force. Fine dust that is not separated by the cyclone dust separating apparatus is filtered using a separate filter at a cyclone body outlet, and cleaned air is discharged through a discharge outlet of a cyclone body or is filtered using a filter disposed downstream of the discharge outlet of the dust separating apparatus.

However, the conventional cyclone dust separating apparatus generates a rotational air current to separate dust, so suction force is lost and noise is increased due to the rotational air current along the path of air. Because elements composing the cyclone dust separating apparatus are disposed in the cyclone body, the space available for collecting dust is reduced. Moreover, when a user dumps collected dust, some of the collected dust escapes from the air inlet where dust-laden air flows into the cyclone dust separating apparatus, contaminating the area around the user.

Furthermore, since the filter of a conventional dust separating apparatus is clogged shortly after cleaning starts, suction force is considerably lowered and consumers doubt the abilities of the vacuum. A clogged filter also results in a burden on a dust vacuum cleaner's motor, which may result in a reduced life span of the motor.

### SUMMARY OF THE INVENTION

Accordingly, to solve at least the above problems and/or disadvantages and to provide at least the advantages described below, it is a non-limiting object of the present invention to provide dust separating apparatus, comprising a main body having a cylindrical shape and including a suction port on a bottom surface and an open upper part, a cover that covers the upper part of the main body and includes a discharge port formed on the same axis as the suction port; and an air guide member protruding from the suction port to the inside of the main body, wherein the air guide member allows the suction port to be in fluid communication with the main body when suction force is generated in the main body and does not allow the suction port to be in fluid communication with the main body when suction force is not generated in the main body.

It is another non-limiting objective of the present invention to provide a dust separating apparatus that further includes a first filter that is spaced apart from the top of the air guide member to filter dust drawn in through the air guide member, a second filter that is formed at the discharge port, and a filter sweeping unit that is formed between the suction port and the discharge port that rotates due to air flow and sweeps dust attached to the second filter.

### BRIEF DESCRIPTION OF THE DRAWINGS

The above and other aspects and/or advantages of the invention will become apparent and more readily appreciated from the following description of the embodiments, taken in conjunction with the accompanying drawings.

FIG. 1 is a perspective view illustrating a partially-cut dust separating apparatus according to an exemplary embodiment of the present invention;

FIG. 2 is a side cross-sectional view illustrating a dust separating apparatus according to an exemplary embodiment of the present invention;

FIG. 3A is a bottom view taken along line 3-3 in FIG. 2 illustrating a dust separating apparatus viewed when suction force is not generated in the dust separating apparatus;

FIG. 3B is a bottom view taken along line 3-3 in FIG. 2 illustrating a dust separating apparatus viewed when suction force is generated in the dust separating apparatus;

FIG. 4 is an enlarged view illustrating part IV in FIG. 2;

FIG. 5 is an elevational view taken ninety degrees to the view in FIG. 2 illustrating a partially-cut dust separating apparatus according to an exemplary embodiment of the present invention;

FIG. 6 is sectional view taken along line 6-6 in FIG. 2 illustrating a dust separating apparatus according to an exemplary embodiment of the present invention.

### DETAILED DESCRIPTION OF EXEMPLARY EMBODIMENTS

Reference will now be made in detail to the non-limiting embodiments of the present invention by way of reference to the drawings, wherein like reference numerals refer to like parts, components and structures.

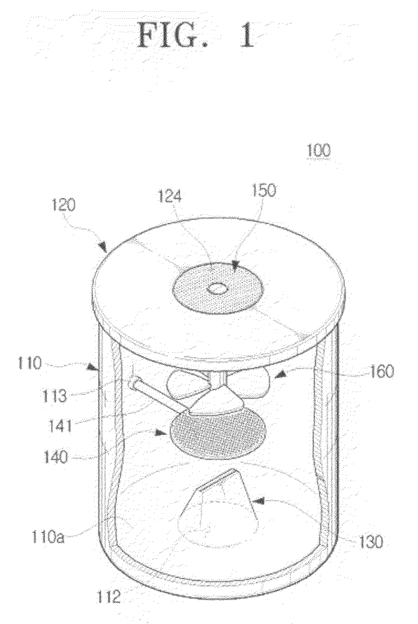

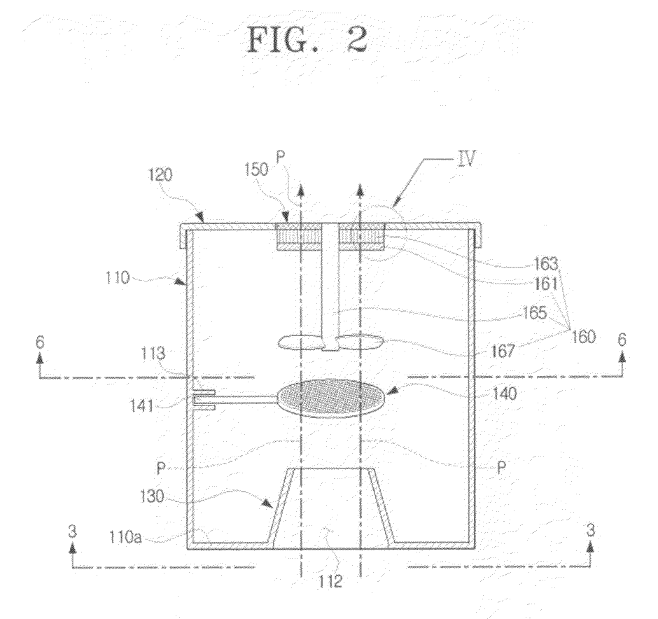

As shown in FIGS. 1 and 2, a dust separating apparatus according to an exemplary embodiment of the present invention includes a main body 110, a cover 120, an air guide member 130, a first filter 140, a second filter 150, and a filter sweeping unit 160.

The main body 110 has a cylindrical shape and an open upper part, and comprises a suction port 112 that has a predetermined radius in the center of a bottom surface 110a.

The cover 120 is connected to the main body 110 to form an enclosed space therein for separating dust, and has a circular plate corresponding to the main body 110 to cover the open upper part of the main body 110. A discharge port 124 having a predetermined radius is formed in the middle of the cover 120 on the same axis as the suction port 112.

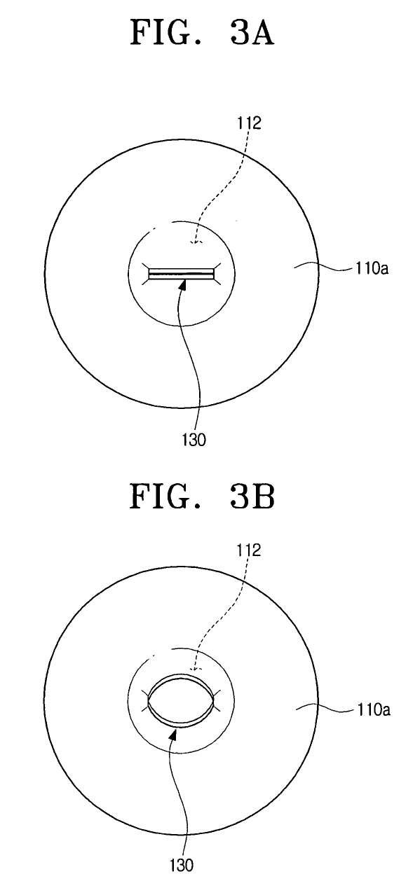

The air guide member 130 selectively allows external air to be drawn into the main body 110 through the suction port 112. If a suction force is not generated in the main body 110, the air guide member 130 prevents external air from being drawn into the main body 110 through the suction port 112. And, if suction force is generated in the main body 110, the air guide member 130 makes external air draw into the main body 110 through the suction port 112. To do so, the air guide member 130 tapers at the top and is made of elastically deformable material such as rubber, silicon, or synthetic resin like film. The bottom of the air guide member 130 is fused to the circumference of the suction port 112, and the top of the air guide member 130 protrudes and is inclined towards the inside of the main body 110 and tapers at the top. If suction force is not generated in the main body 110, the air guide member 130 gets narrower until it is closed in a straight line shape as shown in FIGS. 1 and 3A. Accordingly, when suction force is not generated in the main body 110, the suction port 112 is closed so that the main body 110 is made substantially airtight. If a suction force is generated in the main body 110, the top of the air guide member 130 gets wider due to the pressure of air flowing from the suction port 112 into the main body 110, as shown in FIG. 3B. Subsequently, if the suction force stops being generated, the top of the air guide member 130 is closed again due to being made of elastically deformable material, as shown in FIG. 3A.

The main body 110 is in fluid communication with the suction port 112 only when suction force is generated in the main body 110. Accordingly, when the user dumps dust collected in the main body 110, the top of the air guide member 130 is closed as shown in FIG. 3A. As a result, collected dust is prevented from escaping the suction port 112.

The first filter 140 filters comparatively large dust particles from dust-laden air flowing in through the suction port 112 and prevents comparatively large dust particles from bumping into a rotation fan 167. The first filter 140 is disposed in the same axis as the suction port 112 and the discharge port 124 and is disposed at a predetermined distance from the top of the air guide member 130. The first filter 140 is detachably connected to the main body 110 using a filter support member 141 that has a cylindrical shape and is fixed to one side of the filter 140. The filter support member 141 is inserted into a support groove 113 that is integrally formed on the inner surface of the main body 110 so the filter 140 can be detachably connected to the inner surface of the main body 110.

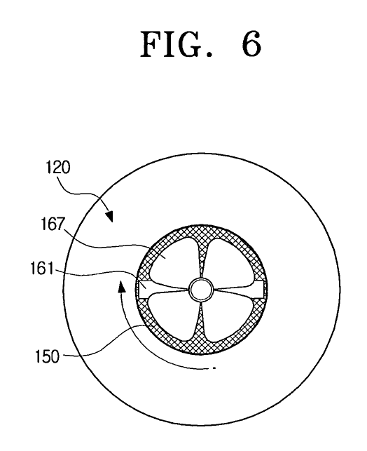

In another exemplary embodiment of the dust separating apparatus 100, the first filter 140 is inclined towards the bottom surface 110a of the main body 110 at a predetermined angle so as to reduce loss of suction force as shown in FIG. 5. The loss of suction force when air flowing in through the air guide member 130 collides with the first filter 140 at an oblique angle due to the inclined disposition of the first filter 140 towards the bottom surface 110a is less than when air flowing in through the air guide member 130 collides with the first filter 140 at right angles due to the disposition of the first filter 140 parallel to the bottom surface 110a.

The second filter 150 separates fine dust that is not filtered through the first filter 140 and is disposed at the discharge port 124 on the cover 120. The second filter 150 is disposed on the same axis as the suction port 112 and the first filter 140 and may be a filter made of finely porous material, such as a fine mesh or a high efficiency particulate air (HEPA) filter to remove fine dust.

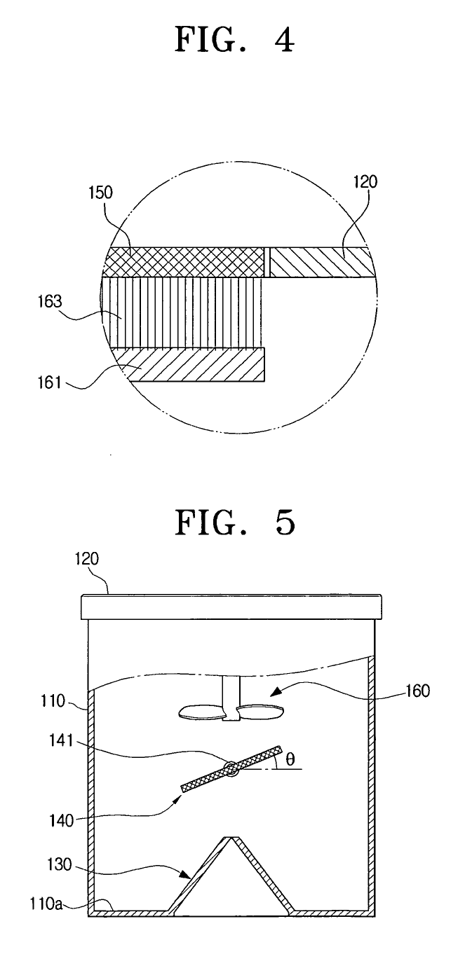

With reference to FIGS. 2, 4, and 6, the filter sweeping unit 160 is disposed between the suction port 112 and the discharge port 124, rotates due to air flow so as to sweep fine dust filtered by the second filter 150, and includes a rotation member 161, a brush member 163, a rotation axis 165, and a rotation fan 167.

The rotation member 161 is disposed at a predetermined distance from the second filter 150, rotates due to rotation of the rotation fan 167, and has a cylindrical shape with the same diameter as the second filter 150.

One end of the brush member 163 is fixed to the rotation member 161, and the other end of the brush member 163 is in contact with the second filter 150.

The rotation fan 167 has a pinwheel shape, is disposed at the lower end of the rotation axis 165 at a predetermined distance from the rotation member 161 to generate rotation force due to air flowing towards the discharge port 124.

The rotation axis 165 protrudes downwards from the center of the second filter 150 towards the bottom surface 110a, with the rotation fan 167 fixed at the lower end thereof. The rotation axis 165 penetrates the center of the rotation member 161 and is rotationally connected to the center of the second filter 150.

Therefore, air flowing towards the discharge port 124 makes the rotation fan 167 rotate, thereby causing the rotation member 161 to rotate so that the brush member 163 disposed at the upper end of the rotation member 161 sweeps filtered dust from the second filter 150. Accordingly, the second filter 150 is cleaned.

In order to clean dust from a filter in a conventional dust separating apparatus, operation of the apparatus must be stopped, the filter must be separated from the apparatus, and the filter must be manually swept from the filter or jarred loose from the filter, typically by bumping the filter into other elements. However, in a dust separating apparatus 100 according to the exemplary embodiment of the present invention, filtered dust on the second filter 150 is swept during operation of the dust separating apparatus so that it is not necessary to stop operation of the dust separating apparatus, to separate the second filter 150 from the apparatus, or to manually sweep or jar the second filter 150.

Operation of the dust separating apparatus 100 according to the exemplary embodiment of the present invention is described below with reference to FIGS. 1 and 2.

When a suction motor (not shown) embedded in a vacuum cleaner generates suction force, the suction force is transferred to the inside of the main body 110 through the suction port 112. When the suction force is generated inside the main body 110, dust-laden air flowing into the main body 110 is flows through the air guide member 130 via the suction port 112 as a result of the difference in pressure caused by the suction force. Accordingly, the top of the air guide member 130 that is closed, as shown in FIG. 3A, becomes open, as shown in FIG. 3B, so that dust-laden external air is drawn into the main body 110 through the suction port 112 and the air guide member 130. Comparatively large dust is filtered using the first filter 140 and becomes attached to the first filter 140. If the suction force is stopped, the comparatively large dust on the first filter 140 is detached and falls to the bottom surface 110a. The air filtered by the first filter then moves to the second filter 150 and is filtered using the second filter 150. When comparatively smaller dust is attached on the second filter 150, it is swept by the filter sweeping unit 160 and falls to the bottom surface 110a. Subsequently, cleaned air is discharged to the outside of the main body 110.

In the dust separating apparatus 100 of the above exemplary embodiment, the suction port 112, the first filter 140, the second filter 150, and the discharge port 124 is disposed in the same axis so that air flows in a straight line as illustrated by lines P in FIG. 2. Accordingly, the air path from the suction port 112 to the discharge port 124 is simple compared with a conventional cyclone dust separating apparatus, which has a complicated air path, so that loss of suction force and noise generated on the air path are reduced. Furthermore, the dust separating apparatus 100 does not need any structure for generating a rotating air current, which allows the space for collecting dust to be expanded.

Moreover, in a dust separating apparatus 100 according to the above exemplary embodiment of the present invention, if dust and contaminants in the main body 100 are collected to a predetermined level, the user may separate the cover 120 from the main body 100 and turn over the main body 100 to dump collected dust and contaminants. The suction port 112 is in fluid communication with the main body 110 and air is drawn into the main body 110 through the suction port 112 only when suction force is generated in the main body 110. Therefore, when a user dumps collected dust and contaminants, the air guide member 130 is closed so that the suction port 112 and the main body 110 are not thus in fluid communication. As a result, collected dust is not leaked through the suction port 112 such that the user does not need to be concerned about dust and contaminants escaping and getting on or around him or her. Additionally, after the cover 120 is separated from the main body 110, the filter supporting member 141 connected to the first filter 140 may be separated from the support groove 113 on the main body 110 so that the first filter 140 can be cleaned.

During the process of separating dust from dust-laden air, air bumps into the rotation fan 167 while air filtered by the first filter 140 flows towards the second filter 150. The rotation fan 167 thus rotates. Consequently, the rotation member 161 connected to the rotation fan 167 through the rotation axis 165 rotates, and the brush member 163 on the rotation member 161 is in contact with the second filter 150 so that dust attached to the second filter 150 is swept. While dust is filtered by the second filter 150, dust attached to the second filter 150 is swept and separated from the second filter 150 at the same time. Accordingly, it is not necessary to stop the operation of the dust separating apparatus 100, to separate the second filter 150 from the dust separating apparatus 100, or to manually sweep or jar filtered dust from the second filter 150.

While the embodiments of the present invention have been described with reference to certain embodiments thereof, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A dust separating apparatus, comprising:
a main body having a cylindrical shape and including a suction port on a bottom surface and an open upper part;
a cover that covers the upper part of the main body and includes a discharge port formed on the same axis as the suction port; and
an air guide member protruding from the suction port to the inside of the main body,
wherein the air guide member allows the suction port to be in fluid communication with the main body when suction force is generated in the main body and does not allow the suction port to be in fluid communication with the main body when suction force is not generated in the main body.

2. The dust separating apparatus of claim 1, wherein
a bottom of the air guide member is connected to the circumference of the suction port,
a top of the air guide member is closed to have a straight line shape if suction force is not generated in the main body, and
the top of the air guide member is open if suction force is generated in the main body.

3. The dust separating apparatus of claim 2, wherein the air guide member is formed of an elastic material.

4. The dust separating apparatus of claim 1, further comprising a first filter spaced from the air guide member to filter dust drawn in through the air guide member.

5. The dust separating apparatus of claim 4, wherein the first filter is fixed to a filter support member which is detachably formed on an inner surface of the main body.

6. The dust separating apparatus of claim 4, wherein the first filter is inclined towards the bottom surface of the main body.

7. The dust separating apparatus of claim 1, further comprising a second filter which is formed at the discharge port.

8. The dust separating apparatus of claim 7, further comprising a filter sweeping unit formed between the suction port and the discharge port that rotates due to air flow and sweeps fine dust attached to the second filter.

9. The dust separating apparatus of claim 8, wherein the filter sweeping unit comprises:
a rotation axis protruding from the center of the second filter towards the bottom surface of the main body;
a rotation fan formed at the lower end of the rotation axis to generate rotational force using air moving towards the discharge port;
a rotation member spaced from the second filter and having a cylindrical shape of the same diameter as the second filter, the rotation member being configured to rotate due to the rotational force generated by the rotation fan; and
a brush member with one end connected to the rotation member and another end in contact with the second filter.
